(19) United States
(12) Patent Application Publication
(10) Pub. No.: US 2011/0143920 A1
(43) Pub. Date: Jun. 16, 2011

(54) Rare Earth Exchanged Catalyst for Use in Detergent Alkylation

(75) Inventors: Deng-Yang JAN, Elk Grove Village, IL (US); Mark G. RILEY, Hinsdale, IL (US); Stephen W. SOHN, Arlington Heights, IL (US); Jaime G. MOSCOSO, Mount Prospect, IL (US); Raelynn M. MILLER, LaGrange, IL (US)

(73) Assignee: UOP LLC, Des Plaines, IL (US)

(21) Appl. No.: 12/639,596

(22) Filed: Dec. 16, 2009

(51) Int. Cl. B01J 29/06; B01J 29/08

(52) U.S. Cl. 502/65; 502/73

(57) ABSTRACT

A catalyst is disclosed for use in the alkylation of benzene with a substantially linear olefin. The catalyst allows for cation exchange with a rare earth element to increase the alkylation of benzene, while reducing the amount of isomerization of the alkyl group. This is important for increasing the quality of the alkylbenzene by increasing the linearity of the alkylbenzene.

### FIELD OF THE INVENTION

The present invention is directed to highly selective, modified catalysts and the process of making the catalysts. The catalysts are related to catalysts for use in the alkylation of aromatic compounds.

### BACKGROUND OF THE INVENTION

Alkylation of benzene produces alkylbenzenes that may find various commercial uses, e.g., alkylbenzenes can be sulfonated to produce surfactants, for use in detergents. In the alkylation process, benzene is reacted with an olefin the desired length to produce the sought alkylbenzene. The alkylation conditions comprise the presence of homogeneous or heterogeneous alkylation catalyst such as aluminum chloride, hydrogen fluoride, or zeolitic catalysts and elevated temperature.

Various processes have been proposed to alkylate benzene. One commercial process involves the use of hydrogen fluoride as the alkylation catalyst. The use and handling of hydrogen fluoride does provide operational concerns due to its toxicity, corrosiveness and waste disposal needs. Solid catalytic processes have been developed that obviate the need to use hydrogen fluoride. Improvements in these solid catalytic processes are sought to further enhance their attractiveness through reducing energy costs and improving selectivity of conversion while still providing an alkylbenzene of a quality acceptable for downstream use such as sulfonation to make surfactants.

Alkylbenzenes, to be desirable for making sulfonated surfactants must be capable of providing a sulfonated product of suitable clarity, biodegradability and efficacy. With respect to efficacy, alkylbenzenes having higher 2-phenyl contents are desired as they tend, when sulfonated, to provide surfactants having better solubility and detergency. Thus, alkylbenzenes having a 2-phenyl isomer content in the range from about 25 to about 35 percent are particularly desired.

Improvements in the catalysts have facilitated the production of linear alkylbenzenes, as shown in U.S. Pat. No. 6,133,492, U.S. Pat. No. 6,521,804, U.S. Pat. No. 6,977,319, and U.S. Pat. No. 6,756,030. However, problems exist with many existing catalysts, and a better understanding, can lead to further improvements in the catalysts.

### SUMMARY OF THE INVENTION

The present invention provides a new catalyst for use in benzene alkylation. The catalyst comprises a zeolite having a silica to alumina molar ratio of less than 8, and incorporates a rare earth element cation into the zeolite at greater than 16.5 wt % of the catalyst, and with alkali, alkaline earth and nitrogen compound cations or mixtures thereof as the remaining cations to balance the framework. The zeolite is an X type zeolite, a Y type zeolite, or a zeolite having EMT/FAU intergrowth.

In one embodiment, the zeolite is an X type zeolite with a silica to alumina molar ratio between 2 and 1.8, and where the rare earth element is exchanged to a degree that the molar ratio of rare earth element to aluminum is between 0.51 and 1.2, when taking the valance change of the rare earth cation into account.

In another embodiment, the zeolite is a Y type zeolite with a silica to alumina molar ratio between 2.8 and 4.

Other objects, advantages and applications of the present invention will become apparent to those skilled in the art from the following drawings and detailed description.

### BRIEF DESCRIPTION OF THE DRAWING

FIG. 1 shows the linearity of catalysts that have retained some alkali cations.

### DETAILED DESCRIPTION OF THE INVENTION

Catalysts are strongly affected by materials that either combine with the catalyst, or can in one form or another reduce the catalytic activity of the catalyst. These materials are poisons to the catalyst, and include materials such as alkali metals, alkaline earth metals and their ions. These poisons are typical, and lead to pretreatments of feeds to catalytic reactors to protect the catalyst, by removing any poisons in the process stream.

The alkylation of aromatics with olefins in important for several commercially important technologies. Ethyl benzene (EB), cumene (isopropyl benzene), and larger chained alkylbenzenes (detergents) are the three most economically important examples. The detergents preferably made using longer chained linear alkyl groups, such as C8 to C13, to form linear alkyl benzenes (LAB). These alkylation reactions are carried out using acid catalysts, either homogeneous catalysts such as HF, or heterogeneous catalyst such as AlCl₃, silica-alumina, and zeolites. Although these are all acid catalyzed processes, there are enough differences that they are all practiced with different catalysts. Skeletal isomerization is an example of a concern in the LAB process, and which makes the use of catalysts suitable for EB or cumene of less value in the LAB process.

The production of linear alkylbenzenes has traditionally been made in two commercial forms, low 2-phenyl and high 2-phenyl. Low 2-phenyl LAB is made by HF alkylation and results in a 2-phenyl concentration between 15 and 20 mass percent of the LAB. This is due to the homogeneous acid, HF, lack of preference for catalyzing the attachment of the benzene to the olefin chain. There is not alkylation on the terminal carbons, and the internal carbons have a nearly equal probability of alkylation, and which produces shorter chained alkyl groups extending from the benzene. High 2-phenyl LAB has historically been made using AlCl₃ alkylation and results in a 2-phenyl concentration between 30 and 35 mass percent of the LAB. While it is possible to produce LAB with different 2-phenyl contents, there is no market for these products, and consequently the efforts have been to replace these environmentally unfriendly catalysts.

In 1995, UOP and Cepsa introduced a detergent alkylation process using the first environmentally friendly solid bed alkylation process for the production of LAB. The catalyst was a fluorided silica-alumina catalyst, and the process produces a high 2-phenyl LAB product. This process has nearly completely replaces the use of AlCl₃ in detergent alkylation. However, it uses considerably more energy than the HF process due to the much higher benzene to olefin ratio in the process, and produces slightly more dialkylate than the HF process.

While ethylbenzene, cumene and LAB are all produced in processes using acid catalysts, there are a number of key features that differentiate LAB from either ethylbenzene or cumene. One is the length of the olefin and the reactions that the olefin can undergo. Solid acid catalysts are know to catalyze both double bond isomerization and skeletal isomerization in linear olefins. Most studies of double bond and skeletal isomerization of linear olefins has focused on 1-butene. This is due to the desire to make isobutene for MTBE, an oxygenate for gasoline, or polyisobutene. Gee and Prampin, Applied Catalysis A: General 360 (2009), 71-80. Even a week acid catalyst, like SAPO-11, produces skeletal isomerization, and is easily observed at 142C, and that skeletal isomerization is temperature dependent.

It is known that skeletal isomerization of linear olefins occurs in the production of LAB over solid acid catalysts. In 1965, in an article titled “Hydroisomerization of Normal Olefins Under Alkylation Conditions” showed that skeletal isomerization was favored by high acid concentrations and high temperatures (Peterson, A. H.; Phillips, B. L.; and Kelly, J. T.; I&EC, 4, No. 4, 261-265, 1965). Also, as shown in U.S. Pat. No. 4,301,317 to Young, Table 2 compares the amount of linear phenyldodecane produced by alkylation of 1-dodecene with benzene over eight different zeolites. All of the zeolites exhibited skeletal isomerization. Inhibiting skeletal isomerization is an important challenge to be addressed, if one is to produce highly linear detergent range alkylbenzenes. It is further worth noting that Beta zeolite, which is commonly used in the production of ethylbenzene and cumene is unsuitable for detergent range LAB production due to its tendency to skeletally isomerizes the linear olefins prior to their alkylation. Because ethylene and propylene only have one isomer, both the double bond and skeletal isomerization of the catalyst are moot and for this reason one cannot predict that a process or catalyst for ethylbenzene or cumene production will necessarily extend to LAB.

A second difference between alkylation of long chain linear olefins with benzene differs from that of ethylbenzene or cumene is the number of products. Ethylbenzene and cumene are unique chemical compounds whereas LAB is a mixture of compounds that results from the fact that long chain linear olefins have multiple positions for the benzene to insert itself. As can be seen from Young's data in U.S. Pat. No. 4,301,317, molecular sieves can reduce or prohibit the formation of some phenylalkane isomers. This is phenomena is called shape selectivity and occurs because the molecular sieve doesn't possess enough space for the molecule to be formed. Since the commercially desirable detergent range linear alkylbenzenes, “low 2-phenyl LAB” and “high 2-phenyl LAB” have relative narrow windows on their 2-phenylalkane content, an acidic molecular sieve catalyst that has good characteristics for producing ethylbenzene or cumene cannot be assumed to be appropriate for producing commercially acceptable detergent range LAB.

A third way in which the alkylation of long chain linear olefins with benzene differs from that of ethylbenzene or cumene is in the impact of the benzene to olefin ratio. Alkylation processes to convert ethylene to ethylbenzene and propylene to cumene operate at significantly low benzene to olefin ratios than solid detergent alkylation processes. It has long been known that monoalkylate selectivity can be maximized by operating at high benzene to olefin ratios. High benzene to olefin ratios also means the ratio of benzene to monoalkylate is high and the higher the weight fraction of benzene relative to other aromatics, the higher the yield of monoalkylate. In the production of ethylbenzene or cumene low benzene to olefin ratios can be employed to minimize energy usage because the polyethylbenzene or polypropylbenzene can be easily transalkylated with benzene to produce the desired product, ethylbenzene or cumene. In the detergent alkylation process, where a solid fluorided amorphous silica-alumina catalyst is employed, shape selectivity does not come into play due to the very large pores and the only way to control the amount of dialkylbenzene is to use high benzene to olefin ratios. Converting long chain linear dialkylbenzenes back to long chain linear monoalkylbenzenes can be done, but with significantly lower efficiency than for ethylbenzene or cumene. Some of the transalkylation occurs though dealkylation followed by alkylation with benzene. When transalkylation occurs through this pathway some of the olefin undergoes skeletal isomerization, which lowers overall product linearity.

Low benzene to olefin ratios also promotes the skeletal isomerization of linear olefins. Because skeletal isomerization is a monomolecular reaction and alkylation is a bimolecular reaction, lowering the benzene to olefin ratio effectively increases the olefin concentration which causes the rate of olefin skeletal isomerization to increase faster than the rate of olefin alkylation. Thus, in solid detergent alkylation processes, one is faced with the choice of operating at high benzene to olefin ratios and accepting the high energy cost or finding catalysts with the appropriate acidity such that skeletal isomerization of the linear olefins is minimal.

It has been found that incorporating some rare earth element cations into a zeolite sodalite cage, the efficiency is increased in producing a primary alkylation product. The means to achieve an increasing amount of rare earth into the structure is by using a lower molar ratio Faujasite and a designed rare earth incorporation technique. By low ratio, it is meant to indicate the silica to alumina molar ratio.

The degrees of rare earth exchange needs to be greater than a certain level to effect the alkylation process. It is shown that the level is around 16.5 wt %. It was also discovered that incorporating some alkali, alkaline earth, or nitrogen compound cations is beneficial in attenuating the skeletal isomerization without sacrificing alkylation activity. The combination of rare earth cation incorporation at greater than 16.5 wt %, and with some alkali, alkaline earth, and nitrogen compound cations, or mixtures thereof, significantly suppresses the isomerization and cracking pathways, while the primary alkylation pathway is not affected. This increases product by decreasing the undesired side reactions that occur. One of the benefits from the new catalyst is a high linearity of the alkylbenzene for use in detergent alkylation. Contrary to what one would expect, it was found that incorporating or leaving some alkali or alkaline earth cations in the catalyst significantly improves catalyst performance. And especially in the performance around the linearity of the alkylbenzene, and the retention of linearity at increased operating temperatures. The present invention is a catalyst designed to provide a product with a linearity of at least 90%.

The present invention comprises a new catalyst for alkylation of aromatics comprising a zeolite having a silica to alumina molar ratio of less than 8, and a rare earth element incorporated into the zeolitic framework. The silica to alumina molar ratio is preferably less than 6 and more preferably less than 5.6. The catalyst can be a low silica to alumina molar ratio Y type zeolite, X type zeolite, or a zeolite have EMT/FAU intergrowth.

The catalyst is formed by using a Y zeolite having a low silica to alumina molar ratio or an X zeolite. The catalyst is normally formed and modified with an alkali, alkaline earth, or nitrogen compound, such as sodium, barium, ammonia or amine, to control the acidity. The catalyst is then ion exchanged with a rare earth element to remove a portion of the alkali or alkaline earth elements, and to provide for larger ions in the zeolites cages. The catalyst can be in extruded or bead form. The catalyst can be prepared by first exchanging the zeolite powder with a rare earth element and then forming the zeolite into pellets or beads. An alternative is to form the zeolite into pellets or beads and then perform the rare earth exchange.

When the catalyst is a Y type zeolite, the silica to alumina molar ratio is between 2.8 and 8, and preferably between 3 and 6, and when the catalyst is an X type zeolite, the silica to alumina molar ratio is between 2 and 3.

The catalyst includes a rare earth element that is incorporated into the sodalite cages. The supercages are large cavities, relative to the pores, in the zeolites that usually have a diameter greater than 1 nm. The supercages are sometimes cavities formed with the intersection of different pores in the zeolite. This is a region where there is less steric hindrance for some catalytic reactions when compared with the pores. This limits undesirable side reactions. Rare earth elements that can be used include at least one of the following: scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thullium (Tm), ytterbium (Yb), and lutetium (Lu). Preferred rare earth elements include at least one of yttrium (Y), lanthanum (La), cerium (Ce), praseodymium (Pr), neodymium (Nd), gadolinium (Gd), dysprosium (Dy), erbium (Er), and ytterbium (Yb).

The rare earth element is cation exchanged with the zeolite sufficient to where the rare earth element to aluminum molar ratio is between 0.51 and 1.2. The catalyst is further cation exchanged with an alkali, an alkaline earth, nitrogen compound cation, or a mixture of thereof.

The catalyst can further include a binder wherein the binder comprises alumina, silica, magnesia, zirconia and mixtures thereof. The binder can also comprise natural or synthetic clays, which are made up of various metal oxides. The binder provides hardness to the catalyst to improve the physical durability of the catalyst from abrasion during operation.

In one embodiment, the catalyst is an X type zeolite having an alumina molar ratio less than 3. A rare earth element is incorporated into the zeolitic framework. The rare earth elements include yttrium (Y), lanthanum (La), cerium (Ce), praseodymium (Pr), neodymium (Nd), europium (Eu), gadolinium (Gd), terbium (Tb), dysprosium (Dy), holmium (Ho), erbium (Er), thullium (Tm), ytterbium (Yb), and lutetium (Lu). Preferred rare earth elements include yttrium (Y), lanthanum (La), cerium (Ce), praseodymium (Pr), neodymium (Nd), gadolinium (Gd), dysprosium (Dy), erbium (Er) and ytterbium (Yb). The rare earth elements contribute to developing steric hindrance within the zeolite pores, and modifying the acidity of the X type zeolite, to reduce the acidity from strong to moderate. It is preferred that the silica to alumina molar ratio is less than 2.8, and more preferably less than 2.5, with a most preferred ratio between 1 and 2.4.

The catalyst has the rare earth elements exchanged to a degree that the molar ratio of rare earth elements to aluminum in the catalyst is in the range between 0.51 and 1.2. A balance of the cation exchange to control the acidity is with alkali or alkaline earth elements.

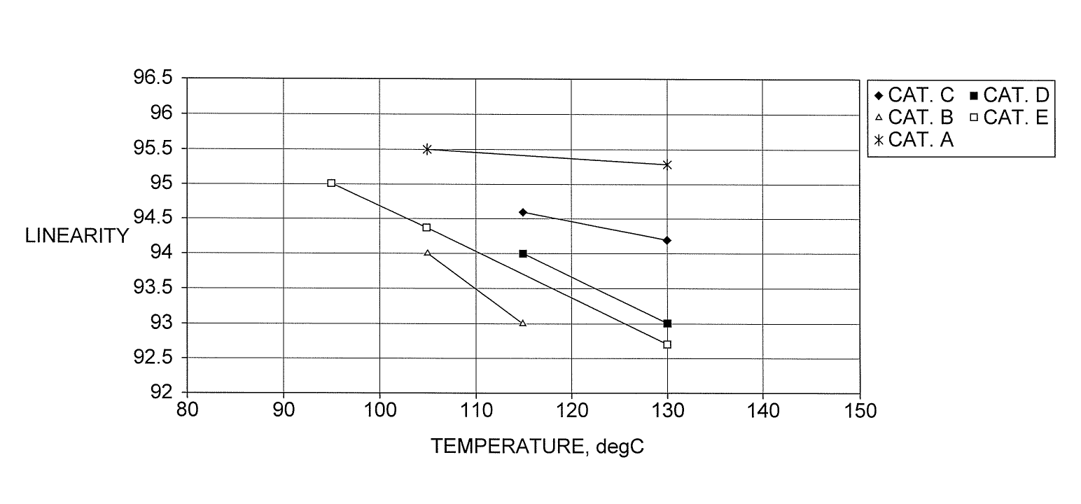

In the detergent alkylation process, the retention of linearity of the alkyl group is important for the quality of the detergents produced from alkylaromatics. It was found that the incorporation of some alkali, or alkaline earth, elements on the catalyst improved the catalyst performance with respect to retaining linearity of the alkyl group without affecting the alkylation reactivity adversely. The results of alkylation tests with the rare earth exchanged catalyst show the high degree of linearity of the product in FIG. 1 over a wide range of operating temperatures.

The process for producing a monoalkylated aromatic compound comprises: passing an aromatic feedstock and an olefinic compound to an alkylation reactor. The alkylation reactor has an alkylation catalyst comprising a zeolite having a silica to alumina molar ratio less than 8 and includes a rare earth element incorporated into the zeolitic framework. The reactor generates an effluent stream comprising the monoalkylated aromatic compound, and is passed to a separation unit. The separation unit recovers the monoalkylated aromatic compound, and generates an aromatic stream and a non-product alkylated aromatic stream. The non-product alkylated aromatic stream generally comprises dialkylated aromatic compounds and can be passed to a transalkylation reactor to improve the product yield.

Aromatic compounds and olefins are reacted under alkylation conditions in the presence of a solid alkylation catalyst. The alkylation conditions generally include a temperature in the range between about 80° C. and about 200° C., most usually at a temperature not exceeding about 175° C., e.g., 100° C. to 160° C. Typically, as the catalyst ages, the temperature of the alkylation is increased to maintain desired activity. The alkylation is an exothermic reaction and thus in a substantially adiabatic reactor, the effluent is at a higher temperature than that of the feed. A substantially adiabatic reactor is one where the increase in temperature of the effluent over that of the feed accounts for at least about 75 percent of heat generated by the reactions in the reaction zone. The preferred aromatic compound is benzene, and the preferred olefins are linear alpha olefins having from 8 to 20 carbon atoms. During the alkylation process, the catalyst deactivates, and the temperature is allowed to increase to compensate for catalyst deactivation. With deactivation, and with increases in temperature, product linearity is reduced. This catalyst minimizes the changes in the product linearity over the life of the catalyst and extends the useful life of the catalyst, by maintaining a higher product linearity during the process, such that with increasing temperature, there is still a high degree of linearity maintained over prior catalysts.

The temperature within a reaction zone is maintained within a suitable range by providing a large excess of aromatic compound to the reaction zone to absorb heat. Where the aliphatic feedstock contains paraffins, the paraffins also serve to absorb heat from the exothermic reactions. High exothermic temperatures during the alkylation can result in untoward effects in terms of not only catalyst deactivation but also in product quality degradation, especially skeletal isomerization, and, in particular, skeletal isomerization of the olefin.

The alkylation reactor is generally a fixed bed type reactor, where the reactants flow through the reactor and the products are separated upon leaving the reactor. The catalyst is generally regenerated through a benzene wash system, and the alkylation reactor system generally comprises at least two reactors with one on-stream, and one off-stream, with the off-stream reactor being regenerated while the on-stream reactor is in operation.

The alkylation reactor can also comprise a plurality of reactors with intercoolers between the reactors to remove heat and maintain the operation in a desirable temperature range.

In one embodiment, the catalyst in the present alkylation reaction process is an X type zeolite having a silica to alumina molar ratio less than 2.8, and the zeolite includes a rare earth element incorporated into the zeolitic framework. The rare earth elements include at least one from the group comprising: yttrium (Y), lanthanum (La), cerium (Ce), praseodymium (Pr), neodymium (Nd), europium (Eu), gadolinium (Gd), terbium (Tb), dysprosium (Dy), holmium (Ho), erbium (Er), thullium (Tm), ytterbium (Yb), and lutetium (Lu).

The alkylation process with the new catalyst also can include the addition of water to the alkylation reactor. The water in the reactor adsorbs onto the catalyst during the reaction, and comprises between 0.5 and 6 weight percent of the total catalyst weight. A preferred amount of water adsorbed onto the catalyst comprises between 1 and 3 weight percent of the total catalyst weight. The amount of water is low and kept to below 1000 ppm by weight of the combined feed of aromatic compound and olefin to the alkylation reactor. Preferably, the amount of water is less than 900 ppm by weight of the combined feed to the reactor.

The alkylation process for detergent alkylation is preferably operated in the liquid phase. To maintain the reactants in the liquid phase, the reactor is operated at a pressure between 1300 and 7000 kPa, with a preferred operating pressure between 2000 and 4000 kPa.

In an alternate embodiment, the process of benzene alkylation comprises passing an aromatic feedstock and an olefinic compound to an alkylation reactor. The alkylation reactor has an alkylation catalyst comprising a Y or X type zeolite having greater than 16.5 wt % of rare earth cations, with the balance being alkali, alkaline earth, or nitrogen compound cations incorporated into the zeolitic framework. The choice of rare earth elements is as stated above. In the preferred operation the catalyst has a silica to alumina molar ratio between 3 and 6.

Experiments were performed where catalyst A is the catalyst of the present invention and catalysts B, C, D and E were prepared for comparative purposes. Catalyst A was prepared by rare earth exchange of Y-54 of 0.3 M of rare earth solution made up from rare earth stock solution obtained from Moly Corp. at 75-80° C. for 2 hours. The exchange utilizes 1.0 gm of rare earth solution per gram of Y-54 powder on an as received basis. At the end of the rare earth exchange, the slurry is filtered under vacuum and the resulting filter cake is washed with 10 grams of de-ionized water per gram of powder. The filter cake is dried and then steamed at 550° C. at 50% steam for 1.5 hours. The steamed rare earth exchanged powder is exchanged with a second rare earth solution and water wash following the same procedure as above. The powder is formulated into a catalyst of cylindrical pellets with 1/16″ (0.16 cm) diameter consisting of 80 wt % zeolite and 20 wt % binder on a volatile free basis.

Catalysts B, C, D and E are prepared following the same procedure used for preparing catalyst A, with the exception that no second rare earth exchange is performed. Instead, an ammonium exchange step of various degrees is performed following the steaming step to yield a final powder of different rare earth and sodium contents. The ammonium exchange is typically done at 70° C. for 1 to 2 hours using a 10 wt % NH₄NO₃ solution.

TABLE
Catalyst Property and Sensitivity of
Product Linearity to Temperatures

| Catalyst | C | D | B | E | A |
|---|---|---|---|---|---|
| Si | 29.3 | 30.3 | 30.7 | 29 | 26.3 |
| Al | 10.7 | 11 | 10.7 | 10.8 | 9.9 |
| Na | 0.16 | 0.19 | 0.058 | 0.22 | 0.55 |
| Ce | 1.51 | 1.64 | 1.48 | 1.95 | 2.72 |
| La | 8 | 7.7 | 7.1 | 7.4 | 10.3 |
| Pr | 1.02 | 0.9 | 0.84 | 0.98 | 1.38 |
| Nd | 2.44 | 2.1 | 2 | 2.25 | 3.25 |
| Si/Al | 2.641 | 2.656 | 2.767 | 2.589 | 2.562 |
| RE/Al | 0.70 | 0.65 | 0.62 | 0.67 | 1.03 |
| wt % RE | 12.97 | 12.34 | 11.42 | 12.58 | 17.65 |
| product linearity | — | −0.0677 | −0.1 | −0.0662 | −0.008 |
| response to | | | | | |
| temperature, | | | | | |
| % deg C.⁻¹ | | | | | |

The catalyst is tested in a plug flow reactor operating at inlet temperatures from 95 to 130° C. The test condition includes a benzene to olefin molar ratio of the feed of about 30, a pressure of 500 psig, and catalyst LHSV is 3.75 hr⁻¹. The reaction is carried out in liquid phase condition. The olefin conversions are 100% or close to 100% with the calculations based on the Bromine Index in the feed and the product. The composition of the product is analyzed by gas chromatography. The product linearity is summarized in FIG. 1. The sensitivity of product linearity to temperature is shown in FIG. 1 and reported also in the Table along with the zeolite properties. The data show that product linearity and the sensitivity of product linearity to temperatures are a function of rare earth and sodium contents. As shown in the Table, Catalyst A contains greater than 16.5 wt % rare earth and has higher sodium content. It shows higher product linearity, which is not sensitive to temperature changes. Conceivably, the catalyst is capable of operating over a wide range of temperatures without incurring changes in product linearity. Furthermore, as the catalyst deactivates with time, the operating temperature needs to be adjusted upward to compensate for the activity degradation. Catalyst A can achieve the goal of maintaining the activity via raising the operating temperature without sacrificing the product linearity.

While the invention has been described with what are presently considered the preferred embodiments, it is to be understood that the invention is not limited to the disclosed embodiments, but it is intended to cover various modifications and equivalent arrangements included within the scope of the appended claims.

1. A catalyst for alkylation of aromatics comprising:
a zeolite having a silica to alumina molar ratio less than 8; and
a rare earth element incorporated into the zeolitic framework in an amount greater than 16.5 wt % with alkali, alkaline earth, nitrogen compound cations, or mixtures thereof, as the remaining cations to balance the framework.

2. The catalyst of claim 1, wherein the silica to alumina molar ratio is less than 6.

3. The catalyst of claim 2, wherein the silica to alumina molar ratio is less than 5.6.

4. The catalyst of claim 1, wherein the zeolite is a low silica to alumina molar ratio Y type zeolite, an X type zeolite, or a zeolite having an EMT/FAU intergrowth.

5. The catalyst of claim 4, wherein the zeolite is a Y type zeolite with a silica to alumina molar ratio between 3 and 4.

6. The catalyst of claim 4, wherein the zeolite is an X type zeolite with a silica to alumina molar ratio between 2 and 3.

7. The catalyst of claim 1, wherein the rare earth elements are selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thullium (Tm), ytterbium (Yb), lutetium (Lu), and mixtures thereof.

8. The catalyst of claim 7, wherein the rare earth elements are selected from the group consisting of yttrium (Y), lanthanum (La), cerium (Ce), praseodymium (Pr), neodymium (Nd), gadolinium (Gd), dysprosium (Dy), erbium (Er), ytterbium (Yb), and mixtures thereof.

9. The catalyst of claim 1, wherein the rare earth elements are exchanged to a degree that the rare earth to aluminum molar ratio is in the range from 0.51 to 1.2.

10. The catalyst of claim 9, wherein the balance of cation exchange is selected from the group consisting of alkali, alkaline earth, nitrogen compound cations, and mixtures thereof.

11. The catalyst of claim 1, further comprising a binder.

12. The catalyst of claim 11, wherein the binder is a clay selected from the group consisting of alumina, silica, magnesia, zirconia, natural or synthetic clays made up of various metal oxides and mixtures thereof.

13. A catalyst for the alkylation of aromatics comprising:
an X type zeolite having a silica to alumina molar ratio less than 3; and
a rare earth element incorporated into the zeolitic framework wherein the rare earth element is selected from the group consisting of yttrium (Y), lanthanum (La), cerium (Ce), praseodymium (Pr), neodymium (Nd), europium (Eu), gadolinium (Gd), terbium (Tb), dysprosium (Dy), holmium (Ho), erbium (Er), thullium (Tm), ytterbium (Yb), lutetium (Lu), and mixtures thereof, wherein the rare earth elements are exchanged to a degree that the rare earth to aluminum molar ratio is in the range from 0.51 to 1.2.

14. A catalyst for alkylation of aromatics comprising:
an X zeolite having a silica to alumina molar ratio less than 2.8; and
a rare earth element incorporated into the zeolitic framework.

15. The catalyst of claim 14, wherein the silica to alumina molar ratio is less than 2.5.

16. The catalyst of claim 14, wherein the rare earth elements are selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thullium (Tm), ytterbium (Yb), lutetium (Lu), and mixtures thereof.

17. The catalyst of claim 16, wherein the rare earth elements are selected from the group consisting of yttrium (Y), lanthanum (La), cerium (Ce), praseodymium (Pr), neodymium (Nd), gadolinium (Gd), dysprosium (Dy), erbium (Er), ytterbium (Yb), and mixtures thereof.

18. (canceled)

19. The catalyst of claim 18, wherein the balance of cation exchange is selected from the group consisting of alkali, alkaline earth, nitrogen compound cations, and mixtures thereof.
